(19) United States
(12) Patent Application Publication
(10) Pub. No.: US 2003/0046532 A1
(43) Pub. Date: Mar. 6, 2003

(54) System and method for accelerating cryptographically secured transactions

(76) Inventor: Matthew Gast, Mountain View, CA (US)

Correspondence Address: Brian T. Rivers, Esq., Nokia, Inc., Mail drop 1-4-755, 6000 Connection Dr., Irving, TX, 75039, US

(21) Appl. No.: 09/944,694

(22) Filed: Aug. 31, 2001

(51) Int. Cl. H04L 9/00

(52) U.S. Cl. 713/151

(57) ABSTRACT

A system and method for accelerating cryptographically secured transactions is disclosed. In an embodiment of the present invention, cryptographically secured transactions are accelerated to increase the speed at which encrypted network transcriptions may be processed by offloading encryption processing to central encryption servers equipped with hardware built to accelerate encryption speed and to reduce encryption latency.

### FIELD OF THE INVENTION

This invention relates generally to computer networking systems and more specifically, to a system and method for providing network security by accelerating cryptographically secured transactions.

### BACKGROUND

Communications over untrusted computer networks are subject to interception and tampering by unauthorized third parties. Without security measures in place, interception and tampering may be carried out without the knowledge of either party to the communication. To protect these communications, cryptographic mechanisms are often employed to create a secure connection. Secure connections between programs on different computers across a network are typically established using the Secure Socket Layer (SSL) protocol, originally developed by Netscape Communications Corporation. SSL is widely accepted as a security mechanism by the Internet Protocol (IP) network security industry and is available in the most commonly used World Wide Web (WWW) browsers from Netscape/AOL and Microsoft.

SSL employs public key cryptographic operations to exchange a shared secret key over untrusted communications networks. Each SSL server is issued a certificate that includes a unique Domain Name System (DNS) identifying name and a public key for the server. Typically the certificate conforms to a standard, such as the X.509, version 3 specification. Certificates are signed by a trusted third party certification authority (CA) such as VeriSign so that users of client computers may be assured of the validity of the information in the certificate.

When a client connects to an SSL-enabled server and requests to protect communications, the server sends its certificate to the client. The client verifies the authenticity of the server's certificate by verifying the CA signature. Signature verification is possible because Web browser software is shipped to users with information from each CA that allows verification of SSL certificates. After certificate validation, the client generates a random session key and selects a private-key encryption algorithm supported by the server. This information is encrypted using the server's public key and returned to the server. Because the response is encrypted, only the server private key can be used to read that information and continue with session establishment. Commonly, browsers use the RC4 stream cipher after session establishment because it provides a high level of security with low computational overhead.

Establishing an SSL session adds computational overhead. The client is responsible for a public-key RSA encryption, while the server is responsible for a corresponding private-key RSA decryption. Private-key RSA operations are far more computationally intensive than public-key RSA operations, which shifts the burden of SSL session establishment to the server. The term “RSA leverage factor” will be used to describe the increase in CPU time required for private-key RSA operations as compared to public-key RSA operations.

The differential between the computational time required for a public-key and a private-key RSA operation depends on the key length and specific hardware, but may range anywhere from a factor of five to a factor of 40. As the length of the modulus increases, the RSA leverage factor also increases. Currently, typical servers use a 1024 bit modulus.

Using SSL to secure sessions is a trade-off of performance (aggregate throughput and numbers of users allowed to connect) for security. The RSA leverage factor implies that to establish a single session, the server must have several times the computational capacity of the client. When multiplied by hundreds or thousands of clients, the CPU power required to use SSL becomes too great. Web site throughput slows as a result because the servers must have many times the computational capacity of the clients currently accessing simply to establish secure sessions. After connection establishment, symmetric encryption continues to burden the CPU and sap throughput. In a worst-case scenario, e-commerce customers cannot access Web sites to conduct transactions. For example, a series of heavily reported outages in the 1999 Christmas season illustrated the potential for poor publicity when existing e-commerce infrastructure is incapable of handling the task.

The RSA leverage factor also provides a crude denial of service attack. Session establishment is dominated by the RSA private-key decryption and is computationally more expensive than the client's RSA public-key encryptions. Malicious clients can easily saturate an SSL-secured Web server's CPU by making a series of apparently legitimate connection requests. Clients will only be required to perform the “easy” public-key encryption while requiring the server to work much harder at the private-key decryption.

One existing solution to the problem of coping with the load of SSL connections is to add encryption hardware to each Web server. Web server software, for example, Apache or Netscape on the Solaris operating system, or Internet Information Server on the Windows NT operating system, may be configured to use acceleration hardware instead of the main system CPU for cryptographic operations. When such acceleration hardware is used, hardware device drivers must be installed so that the server operating system can recognize and route computations to the encryption assistance hardware. The need for hardware device drivers that are compatible with a particular operating system presents problems for users of systems running less popular operating systems that have not gained market acceptance. For example, a typical hardware device driver vendor would be less motivated to design, distribute and sell hardware drivers on a niche computing platform such as FreeBSD because the market is much smaller than the market for systems running Windows NT or Solaris.

Adding encryption hardware can also be prohibitively expensive. For example, the cost of adding hardware acceleration cards to each server in a server farm becomes expensive in proportion to the number of servers. Also, since the queuing system does not spread the load of providing services, there is a tendency for queues to run at less than full capacity.

Another problem with typical hardware acceleration cards is scalability. Device drivers pass encryption requests from the CPU to the hardware. If a device driver adds significant queuing and calling overhead, or if the operating system on the server implements the driver's system calls inefficiently, the performance is degraded.

Security architects are frequently concerned by the use of end-to-end strong cryptography. For example, encrypted tunnels provide an attack vector into the network. Perimeter filtering is ineffective against packets whose contents are deliberately obscured. Tunnels frequently are used to connect semi-trusted partners to business systems across an untrusted network. Taking control of one endpoint of a tunnel allows an attacker (or a malicious insider at a partner site) to inflict great damage. Providing intrusion detection for SSL sessions has not been a possibility until the advent of SSL termination devices.

Another problem with existing solutions is that the Wireless Application Protocol (WAP) suite has a major perceived security flaw. Nearly all security experts have examined the WAP security specification and noted that encrypted data must be held in cleartext at the WAP server. To understand why, consider the method by which secure connections are built from WAP handsets to secure Web servers. Handsets connect to the WAP server. A variety of encryption mechanisms protect the handset-WAP server connection: the air interface between the handset and the base station is secured by the A5 algorithm, and the handset-WAP server connection may also be secured by the Wireless Transport Layer Security (WTLS) protocol. However, the WTLS connection carries data in the wireless markup language (WML). In order to access Web sites on the Internet, two translations must occur. First, the WML must be converted into the hypertext markup language (HTML). Second, WTLS must be converted to its Internet-standard equivalent, SSL. Unfortunately, translation is not compatible with strong end-to-end security. In order to take the WML and convert it to HTML, the data must be present in the clear.

When software programs have cleartext data in memory, a wide variety of attacks can be made to gain access to that data. A crude, but effective, attack is to crash the program and examine the core dump file it leaves behind. Core files are supposed to aid developers in debugging by saving the contents of memory, but they also aid attackers by saving the private data the developers have taken such great pains to protect. Numerous other attacks may also be made to cleartext in memory.

### SUMMARY

A system and method are provided for providing network security. In an embodiment of the present invention, cryptographically secured transactions are accelerated to increase the speed at which encrypted network transactions may be processed by offloading encryption processing to central encryption servers equipped with hardware built to accelerate encryption speed and to reduce encryption latency.

### BRIEF DESCRIPTION OF THE DRAWINGS

A more complete understanding of the system and method of the present invention may be had by reference to the following detailed description when read in conjunction with the accompanying drawings wherein:

FIG. 1 is a flow chart illustrating steps that may be performed in a method for providing network security in accordance with an embodiment of the present invention.

FIG. 2 is a block diagram illustrating a system for providing network security in accordance with an embodiment of the present invention.

FIG. 3 is a block diagram illustrating a system for providing network security in accordance with an embodiment of the present invention.

FIG. 4 is diagram illustrating conceptually an example of the contents of a network protocol packet that may be input to a system and method for providing network security in accordance with an embodiment of the present invention.

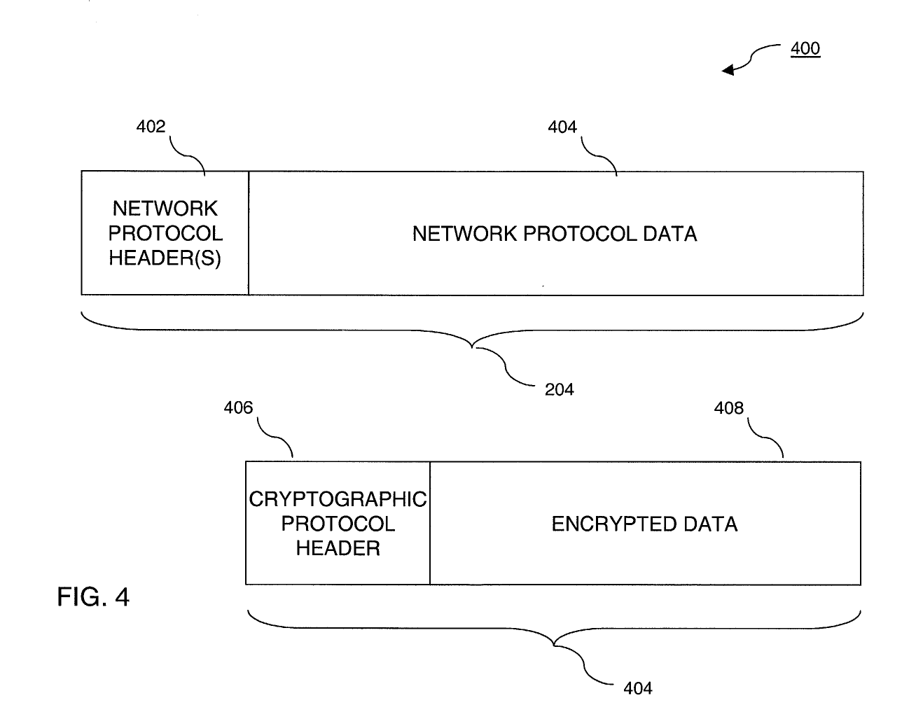

### DETAILED DESCRIPTION

In a typical untrusted computer network, Nokia security devices are deployed as security gateways at network choke points (“service integration points”), but the security mechanisms to protect communications between computers are typically handled by the content servers. Content servers perform the CPU-intensive task of providing personalized content. When security mechanisms are handled on the content servers, this takes CPU cycles away from the task of providing user-specific content.

By moving the task of processing the security mechanisms to the network choke points, for example to the security device, the security device may then behave as a central encryption server as well as a security gateway, leaving the content servers free to serve content. Off-loading the resource-intensive cryptographic operations from the content servers onto a central control point such as a service integration point may result in a performance increase and enhance maintainability.

Controlling the processing of security mechanisms centrally, as opposed to processing them on the content servers, may provide some advantages. For example, in an embodiment of the present invention, requests for encrypted sessions will be statistically multiplexed so users may obtain higher utilization rates of cryptographic assistance hardware. The higher utilization rates results in more efficient use of the cryptographic hardware, thus reducing the total cost. In another example embodiment of the present invention, central control of the security mechanism processing may provide a single point for the management of keys and certificates. Deployment of central control at the service integration points may also provide further leverage of third party applications. For example, an SSL termination device may provide the ability to have intrusion detection systems monitor the encrypted data stream, in addition to providing a performance increase that stems from off-loading the expensive cryptographic operations from the content servers.

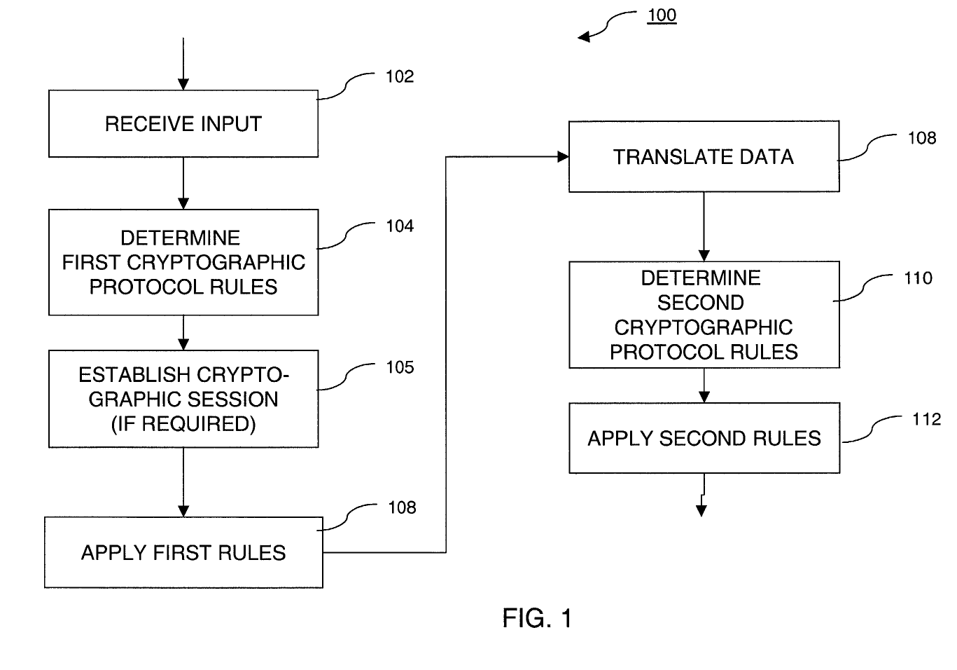

FIG. 1 illustrates a flow chart 100 showing steps that may be performed in a method for providing network security in accordance with an embodiment of the present invention. In step 102, a plurality of network protocol packets 204 is received. A network protocol may be defined as a means of delivering data packets across a network to a program running on a remote system. Network protocol information may be implemented by a plurality of distinct headers. A network protocol packet 204 may include a network protocol header 402 and a plurality of network protocol data 404. The network protocol data 404 is associated with a first cryptographic protocol 302 and may include a first cryptographic protocol header 408 and a first plurality of encrypted data 408. In an example embodiment of the present invention, the network protocol packet 204 may be an IP packet in which the network protocol header 402 is an IP header that contains information indicating that the network protocol data 404 is associated with ESP. In this case the cryptographic protocol header 406 may be an ESP header and the encrypted data 408 may be encrypted in accordance with ESP encryption rules. In another example embodiment of the present invention, the network protocol header 402 may be an IP packet in which the IP header contains information indicating that the network protocol data 404 is associated with TCP. In this case the cryptographic protocol header 406 may be a TCP header. The TCP header may use a port number to indicate that the encrypted data 408 includes a stream of Secure Sockets Layer (SSL) data that may be decrypted using SSL rules.

In step 104, a first plurality of cryptographic protocol rules 302 associated with the network protocol data 404 are determined. In step 105, the first plurality of cryptographic protocol rules 302 are used to establish a protocol session with the remote session endpoint. This step is performed if required by the first cryptographic protocol rules 302.

In step 106, the first plurality of cryptographic protocol rules 302 are applied to the first encrypted data 408 to obtain a first plurality of cleartext data 304.

In step 108, the first plurality of cleartext data 304 is translated into a second plurality of cleartext data 208 associated with a second data type 306 in accordance with at least one translation rule 308. There may be a plurality of translation rules 308. The translation rules 308 may be predetermined or may be determined dynamically or on the fly.

In step 110, a second plurality of rules associated with a second cryptographic protocol 310 to be applied to the second plurality of cleartext data 210 associated with a second data type 306 is determined.

In step 112, the second plurality of cleartext data associated with a second data type 306 is encrypted by the cryptographic acceleration module 214 in accordance with at least one rule associated with a second cryptographic protocol 310, resulting in a second plurality of encrypted data 216. Second plurality of encrypted data 216 may be made available as the output of output module 212.

In an embodiment of the present invention, network protocol headers may be used to establish that an IP packet is carrying a TCP segment, and said TCP segment is carrying SSL as the related cryptographic protocol. The first cryptographic protocol 304 may be associated with WTLS and the second cryptographic protocol 306 may be HTTP over SSL. The first plurality of cleartext 208 may be associated with a data type such as WML and the second plurality of cleartext data 210 may be associated with a data type such as HTML. The first cryptographic protocol and the second cryptographic protocol may be identical. The first cryptographic protocol may be associated with a first type of network and the second cryptographic protocol may be associated with a second type of network, for example, a wired network and a wireless network. The first plurality of encrypted data 408 (contained in network protocol packet 204) and the second plurality of encrypted data 216 may conform to different revisions of a specification for the same cryptographic protocol. In a more trivial case, where the first data type 304 and the second data type 306 are identical, then translation would not be necessary.

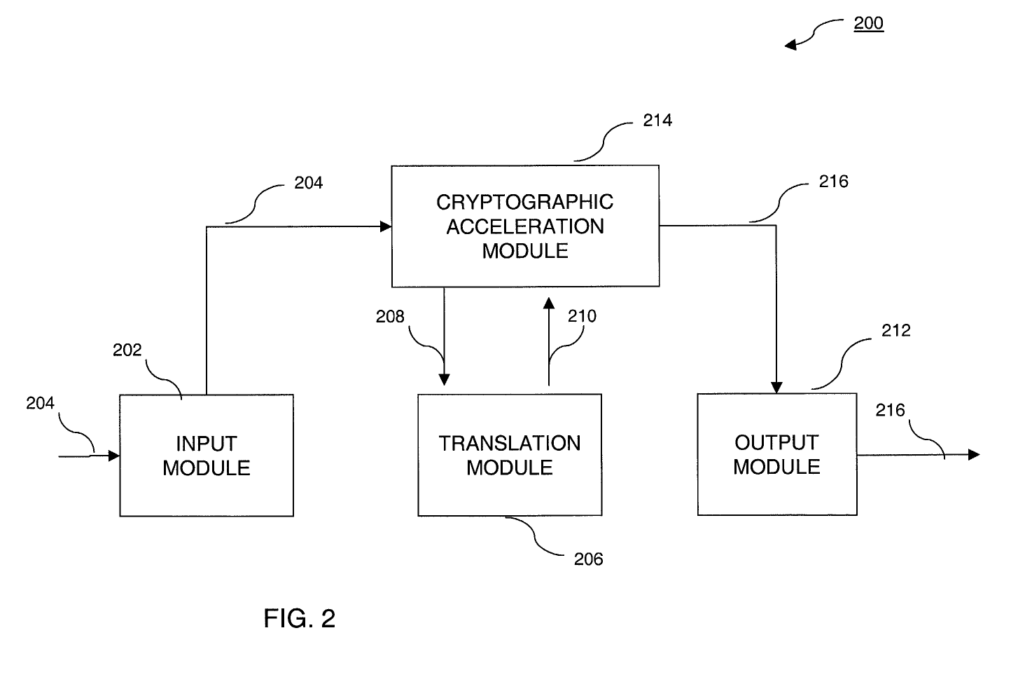

FIG. 2 is a block diagram 200 illustrating a system for providing network security in accordance with an embodiment of the present invention. The system may include an input module 202 for receiving a plurality of network protocol packets 204, a translation module 206 for translating a first plurality of data 208 into a second plurality of data 210, an output module 212, and a cryptographic module 214 responsive to the input module 202 and the output module 212 for performing cryptographic operations. Cryptographic acceleration module 214 decrypts network protocol packets 204 into a first plurality of cleartext data 208, and encrypts second plurality of cleartext data 210 to provide a second plurality of encrypted data 216.

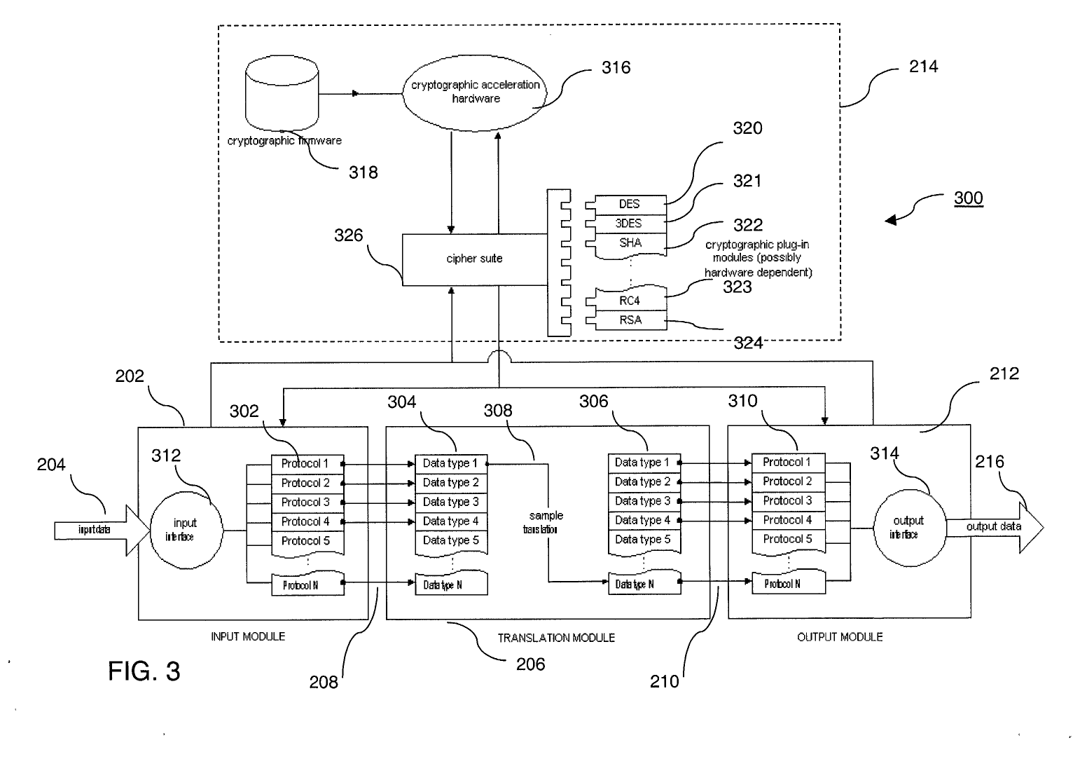

In an embodiment of the present invention, the system for providing network security may include means for receiving a request to perform a cryptographic operation 202, means for returning a response to the cryptographic operation request 212, and at least one module for performing said cryptographic operations 214. The cryptographic operations module 214 may include, for example, a cryptographically strong random number generator. The cryptographic operations may be performed using cryptographic acceleration hardware 316, discussed in connection with the description of FIG. 3 below.

FIG. 3 is a block diagram 300 illustrating an example of a system for providing network security in accordance with an embodiment of the present invention. The system may include an input module 202, a translation module, a cryptographic acceleration module 214 and an output module 212. The input module receives network protocol packets 204, processes them in accordance with cryptographic module 214, and passes the first cleartext data 208 to translation module 206. Translation module 206 translates the first cleartext data 208 into second cleartext data 210 in accordance with translation rules 308, passes the second cleartext data 210 to output module 212 where the second cleartext data 210 is processed in accordance with cryptographic acceleration module 214, resulting in second encrypted data 216.

The cryptographic operations may be performed using cryptographic acceleration hardware 316. Cryptographic acceleration hardware may work in association with cryptographic firmware 318 that may be easily more easily upgraded than replacing hardware. The cryptographic acceleration hardware 316 may include a plurality of individual units 320-324. Individual units 320-324 may be implemented as hardware acceleration units. Individual units 320-324 may be plug-in modules that may be implemented in hardware, software or both. The plug-in modules may be included as part of a cipher suite module 326. At least one individual unit 320-324 may be dedicated to one function. For example, individual unit 320 is shown as being dedicated to DES, individual unit 321 is shown as being dedicated to 3DES, individual unit 322 is shown as being dedicated to SHA, individual unit 323 is shown as being dedicated to RC4, and individual unit 324 is shown as being dedicated to RSA. These examples are not exhaustive and may include numerous additional cryptographic protocols and encryption/decryption algorithms that may be added later, including algorithms that have not yet been developed. The cryptographic acceleration module 214 may be updateable by loading at least one cryptographically signed instruction. The cryptographic acceleration module 214 may be tamper-resistant. The cryptographic acceleration module 214 may be tamper-evident. The cryptographic operations module 214 may provide for the storage of keys and operations with keys in hardware to prevent key-recovery attacks.

Input module 202 may include an input interface 312 that may be physical network hardware, such as Ethernet, to allow the use of a multiple network-layer protocols 302 over a hardware interface 312. Furthermore, network-layer protocols such as IP may allow the use of multiple applications by providing session layer protocols, for example TCP, and process-layer identifiers, for example, TCP and UDP port numbers. Output module 212 may include an output interface 314 that may be physical network hardware similar to input interface 312.

In accordance with various embodiments of the present invention, the following references may be used when selecting various implementation details and are incorporated herein by reference: RFC 791 (IP); RFC 792 (TCP); RFC 2068 (HTTP1.1); Federal Information Processing Standard (FIPS) 180-1 on Secure Hash Algorithm (SHA); ITU-T Recommendation X.509 on digital certificates; FIPS 46-3 on Data Encryption Standard (DES); RFC 2246 for Transport Layer Security (TLS); RFC 1321 (MD5); RFC 2104 on hashed message authentication code (HMAC), RFC 2040 (RC5); expired U.S. Pat. No. 4,405,829 (RSA); “Applied Cryptography” by Bruce Schneier, ISBN 0-471-11709-9 (Diffie-Hellman cryptography); parts of the SSL protocol specification disclosed in U.S. Pat. No. 5,657,390; WTLS Specifications as available from the WAP Forum, including, but not limited to, document numbers WAP-163 and WAP-199, and WTLS 1.1 version Feb. 11, 1999; and open source software including parts of OpenSSL (http://www.openssl.org), mod₁₃ ssl (www.modssl.org), and Apache (http://www.apache.org).

It is to be understood that the foregoing description is intended to illustrate and not limit the scope of the invention, the scope of which is defined by the appended claims. Other aspects, advantages, and modifications are within the scope of the following claims. Although described in the context of particular embodiments, it will be apparent to those skilled in the art that a number of modifications to these teachings may occur. Thus, while the invention has been particularly shown and described with respect to one or more preferred embodiments thereof, it will be understood by those skilled in the art that certain modifications or changes, in form and shape, may be made therein without departing from the scope and spirit of the invention as set forth above and claimed hereafter.

What is claimed is:

1. A method for providing network security, comprising the steps of:
receiving a plurality of network protocol packets, wherein a network protocol packet includes a network protocol header and a plurality of network protocol data, and wherein the network protocol data include a first cryptographic protocol header and a first plurality of encrypted data;
determining a first plurality of cryptographic protocol rules associated with the network protocol data;
establishing a cryptographic session, if required by said first cryptographic rules;
applying the first plurality of cryptographic protocol rules to the first encrypted data to obtain a first plurality of cleartext data;
translating the first plurality of cleartext data into a second plurality of cleartext data in accordance with at least one translation rule; and
encrypting the second plurality of cleartext data in accordance with at least one rule associated with a second cryptographic protocol, resulting in a second plurality of encrypted data.

2. A system for providing network security, comprising:
an input module for receiving a plurality of network protocol packets;
a translation module for translating a first plurality of data into a second plurality of data;
an output module; and
a cryptographic module responsive to the input module and the output module for performing cryptographic operations.

3. A system for providing network security, comprising:
means for receiving a request to perform a cryptographic operation;
means for returning a response to the cryptographic operation request;
at least one module for performing said cryptographic operations.

4. The method of claim 1, wherein the at least one translation rule is predetermined.

5. The method of claim 1, wherein the at least one translation rule is determined dynamically.

6. The method of claim 1, wherein the first cryptographic protocol is WTLS.

7. The method of claim 1, wherein the first plurality of encrypted data is associated with WML.

8. The method of claim 1, wherein second plurality of encrypted data is associated with HTML.

9. The method of claim 1, wherein the second cryptographic protocol is SSL over HTTP.

10. The method of claim 1, wherein the first cryptographic protocol and the second cryptographic protocol are identical.

11. The method of claim 1, wherein the first plurality of encrypted data and the second plurality of encrypted data conform to different revisions of a specification for the same cryptographic protocol.

12. The system of claim 3, wherein at least one cryptographic module is a cryptographically strong pseudorandom number generator.

13. The system of claim 3, wherein the cryptographic operations are performed using cryptographic acceleration hardware.

14. The system of claim 13, wherein the cryptographic acceleration hardware includes a plurality of individual hardware acceleration units.

15. The system of claim 14, wherein at least one individual hardware acceleration unit is dedicated to one function.

16. The system of claim 13, wherein the cryptographic acceleration hardware is updateable by loading at least one cryptographically signed instruction.

17. The system of claim 13, wherein the cryptographic acceleration hardware is tamper-resistant.

18. The system of claim 13, wherein the cryptographic acceleration hardware is tamper-evident.
